(19) United States
(12) Patent Application Publication
(10) Pub. No.: US 2023/0142511 A1
(43) Pub. Date: May 11, 2023

(54) Assembly comprising a set of strands and a diagnostic device for diagnosing the state of the set of strands

(71) Applicants: Université de Nantes, NANTES (FR); ICAM OUEST, CARQUEFOU (FR)

(72) Inventors: Benjamin DECUREY, NANTES (FR); Virginie GAILLARD, SUCE-SUR-ERDRE (FR); Marion GIRARD, SAINT NAZAIRE (FR); Romain GRANGEAT, SAINT NAZAIRE (FR); Frederic JACQUEMIN, SAINT VIAUD (FR); Yann LECIEUX, NANTES (FR); Dominique LEDUC, NANTES (FR); Cyril LUPI, NANTES (FR)

(21) Appl. No.: 17/912,780

(22) PCT Filed: Mar. 4, 2021
(86) PCT No.: PCT/FR2021/050367

§ 371 Date: Sep. 19, 2022

(30) Foreign Application Priority Data
Mar. 19, 2020 (FR) FR2002686

(51) Int. Cl. G01D 5/353; B63B 21/20

(52) U.S. Cl. CPC G01D 5/35341; B63B 21/20; B63B 2021/203

(57) ABSTRACT

Assembly comprising: a set of strands that extends in a direction of tension in which the set of strands is intended to experience tensile stresses; at least one diagnostic fiber that is integrated into the set of strands and able to conduct light, the light propagating through the diagnostic fiber between an entrance end and an exit end, that extends in the direction of tension, and that has a mechanical tensile strength close to that of one of the strands; and a diagnostic device comprising a light source for sending a light beam into the diagnostic fiber via the entrance end, a first optical sensor for delivering a signal representative of the light intensity at the exit end of the diagnostic fiber, the light intensity at the exit end of the diagnostic fiber being correlated to the mechanical state of the diagnostic fiber.

### TECHNICAL FIELD OF THE INVENTION

The present invention relates to the field of detecting degradations in a set of strands.

The invention has a privileged application in the field of submerged cables such as mooring cables and makes it possible to detect a ruptured cable or degradation of the mechanical performances thereof.

However, the invention is not limited to such a field of application and typically relates to materials comprising a set of strands, the strands extending mainly in a so-called direction of tension in which the set of strands is intended to experience tensile stresses. Thus, the invention can be applied to ropes, fabric bands, straps or composite materials.

The invention relates more particularly to an assembly comprising a set of strands and a diagnostic device for diagnosing the state of the set of strands.

### TECHNICAL BACKGROUND

The mooring or anchor cables are submerged structures, the mechanical state of which cannot be checked with the naked eye when they are in use.

It is known to insert a silica optical fiber into a cable and to connect this cable to a diagnostic device. The diagnostic device comprises a light source arranged to send a light beam propagating through the fiber and an optical sensor capable of delivering a signal representative of the light intensity of the beam at the exit of the optical fiber. Thus, the diagnostic device makes it possible to detect a ruptured optical fiber when the light intensity measured is zero.

However, silica is a material which has low mechanical tensile strength. The strands of a mooring cable are made from a material having a mechanical tensile strength well above that of the silica. Thus, the state of a silica optical fiber integrated into a mooring cable is not representative of the state of the structural strands of the cable. This results in a lack of reliability and performance of the devices for diagnosing the state of a cable of the prior art.

### SUMMARY OF THE INVENTION

The invention proposes an assembly comprising a set of strands according to which:
the strands mainly extend in a so-called direction of tension in which the set of strands is intended to experience tensile stresses
all the strands that form the set are made from the same material with the same mechanical tensile strength, the strands are able to conduct light at least for certain wavelengths of light,
at least one strand of the set constitutes a diagnostic fiber so that the diagnostic fiber is able to conduct light, the light propagating through the diagnostic fiber between an entrance end and an exit end.

The assembly comprises a diagnostic device comprising:
a light source arranged to send a light beam into the diagnostic fiber via the entrance end,
a first optical sensor capable of delivering a signal representative of the light intensity at the exit end of the diagnostic fiber, the light intensity at the exit end of the diagnostic fiber being correlated to the mechanical state of the diagnostic fiber.

According to other features of the invention:
the set of strands is a mooring and/or anchor cable,
the set of strands is a fabric band or even a strap,
the diagnostic fiber is made of polymer and preferably nylon,
the entrance end and the exit end are one and the same end of the diagnostic fiber and the diagnostic fiber comprises a distal end opposite the entrance end and reflecting the light inside the diagnostic fiber,
the diagnostic fiber is folded in two so that the entrance end and the exit end are juxtaposed,
the diagnostic device further comprises a second optical sensor, and a beam splitter arranged to split a light beam from the light source into a first beam sent into the diagnostic fiber and a second beam sent into the second optical sensor
the set of strands comprises several diagnostic fibers, and the first optical sensor is a camera generating images of the exit ends of the diagnostic fibers,
the assembly comprises a communication module programmed to transmit the signal from the optical sensor or sensors to a remote control unit.

### BRIEF DESCRIPTION OF THE FIGURES

Further features and advantages of the invention will become apparent from the following detailed description, which may be understood with reference to the attached drawings in which:

FIG. 1 is a perspective view of a coiled mooring cable;

FIG. 2 is a perspective view of one end of the mooring cable of FIG. 1 once it is attached to a floating barge;

FIG. 3 is a functional diagram of an assembly according to one embodiment of the invention;

FIG. 4 is a schematic perspective view of a cross-section of a set of strands according to one embodiment of the invention;

FIG. 5 is a schematic perspective view of a set of strands according to a first embodiment of the invention;

FIG. 6 is a schematic perspective view of a set of strands according to a second embodiment of the invention;

FIG. 7 is an image of one end of a set of strands provided by a camera of a diagnostic device according to one embodiment of the invention.

### DETAILED DESCRIPTION OF THE INVENTION

In the following description, identical, similar or analogous elements will be referred to by the same reference numbers.

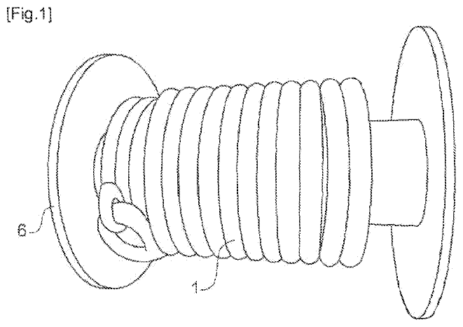

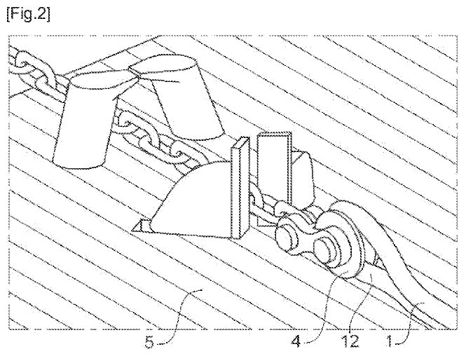

The invention is more particularly disclosed in the framework of its application to a mooring cable such as that shown in FIGS. 1 and 2.

The mooring cable constitutes a set 1 of strands. In FIG. 1, the cable is shown coiled about a support 6. It is thus not in service. In FIG. 2, the cable is put in service and deployed on a platform 5. The cable comprises one end forming a loop 12 engaged on a pulley 4 attached to the platform 5. In service, the cable comprises a portion that is practically submerged over its entire length.

However, as mentioned above, the invention is not limited to such an application and can apply to ropes, fabric bands, straps or composite materials.

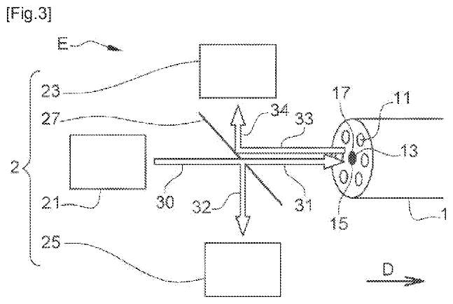

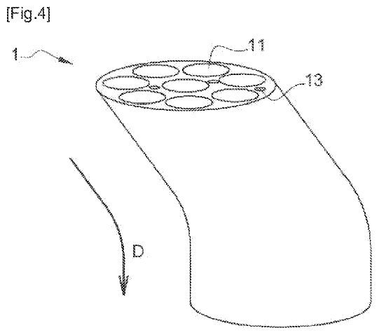

Reference is now made to FIGS. 3 and 4 to disclose an assembly E according to one embodiment of the invention. The assembly E comprises a set 1 of strands and a diagnostic device 2.

The set 1 comprises strands 11 made from the same material. The strands 11 mainly extend in a direction D of tension in which the set 1 of strands 11 is intended to experience tensile stresses.

The strands 11 can be held together in different ways. The strands can be:
twice-laid and/or braided together,
woven together,
tied together, for example by a sheath,
bonded together, for example by a thermosetting or thermoplastic polymer.

According to one particular feature of the invention, the set 1 of strands comprises diagnostic fibers 13.

Each diagnostic fiber 13 is able to conduct light. In other words, each fiber is transparent at least for certain wavelengths of light. The light propagates through the diagnostic fiber 13 between an entrance end 15 and an exit end 17.

The diagnostic fiber 13 can be made of polymer. The diagnostic fiber 13 is, for example, made of transparent nylon. As a variant, the diagnostic fiber 13 can be made of polymethyl methacrylate, commonly abbreviated as “PMMA”.

The diagnostic fibers 13 extend mainly in the direction D of tension. The diagnostic fibers 13 are integrated into the set 1 in the same way as the strands 11. The fibers can be:
twice-laid and/or braided with the strands 11,
woven with the strands 11,
tied with the strands 11, for example by a sheath,
bonded with the strands, for example by a thermosetting or thermoplastic polymer.

Each diagnostic fiber 13 has a mechanical tensile strength close to that of one of the strands 11. For example, the diagnostic fiber 13 has a mechanical tensile strength equal to that of one of the strands 11 to within 5%.

According to a particular embodiment of the invention, the diagnostic fibers 13 can be strands 11 of the set 1 themselves. This is possible when the strands 11 are able to conduct light at least for certain wavelengths of light, as is the case for example for strands 11 made from transparent nylon.

In this case, some of the strands 11 of the set 1 are both designed to experience tensile stresses and both used to diagnose the mechanical state of the strand 11 itself and thus to detect any degradation via light intensity measurements inside the strand 11 that is able to conduct light.

According to another particular embodiment of the invention, the diagnostic fibers 13 are optical fibers discrete from the strands 11 of the set 1. The diagnostic fibers 13 extend along the entire length of the set 1 of strands.

The diagnostic device 2 comprises a light source 21, a first optical sensor 23, a second optical sensor 25 and a beam splitter 27.

The light source 21 emits a primary light beam 30.

The light source is, for example, a laser. The light beam 31 entering the diagnostic fiber 13 is then spatially and temporally consistent.

As a variant, the light source 21 can be a light-emitting diode or lamp, commonly abbreviated as “LED”.

The beam splitter 27 and beam splitter cube is arranged to split the primary light beam 30 from the light source 21 into a first beam 31 sent into the diagnostic fiber 13 at the entrance end 15 and a second beam 32 sent into the second optical sensor 25.

The light beam 31 is sent into the diagnostic fiber 13. Part of the light beam 31 propagates through the diagnostic fiber 13 and comes out in the form of an exit beam 33. The beam splitter 27 intercepts the exit beam 33. Part of the exit beam 33 is reflected in the form of a measuring beam 34. The measuring beam 34 penetrates the first optical sensor 23.

The first optical sensor 23 is capable of delivering a signal representative of the light intensity at the exit end 17 of the diagnostic fiber 13. The first optical sensor 23 is, for example, a photodetector like a photodiode or a camera coupled to an image processing device.

The light intensity at the exit end 17 of the diagnostic fiber 13 is correlated to the mechanical state of the diagnostic fiber 13. When the diagnostic fiber 13 is in good condition, the light intensity measured at the exit end 17 is maximal, when the diagnostic fiber 13 is broken, the light intensity measured at the exit end 17 is zero and when the diagnostic fiber 13 is damaged, the light intensity measured at the exit end 17 has an intermediate value between the maximum value and the zero value.

The second optical sensor 25 is capable of delivering a signal representative of the light intensity of the second beam 32. The second optical sensor 25 is, for example, a photodetector like a photodiode.

The second optical sensor 25 makes it possible to detect a failure of the light source 21. In particular, the second optical sensor 25 makes it possible to determine the cause of an intensity measurement by the first optical sensor 23 being less than the maximum value. This cause is either a failure of the light source 21, or a deterioration of the diagnostic fiber 13. The second optical sensor 25 makes it possible to avoid wrongly detecting a deterioration of the diagnostic fiber 13.

When the set 1 of strands 11 is a partially submerged cable, it is advantageous if the electronic components of the diagnostic device 2 such as the light source 21, the first optical sensor 23, and the second optical sensor 25 are positioned at a non-submerged end of the cable in order to limit the deterioration of the electronic components by the water, particularly by seawater. In this case, the entrance end 15 and the exit end 17 of the diagnostic fibers 13 must both be positioned in a non-submerged end of the cable.

In the example of FIGS. 1 and 2, the entrance end 15 and the exit end 17 of the diagnostic fibers 13 are positioned in the loop 12. The diagnostic device 2 can also be integrated into the loop 12 shown.

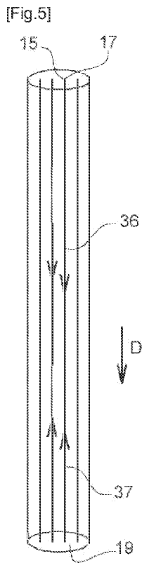

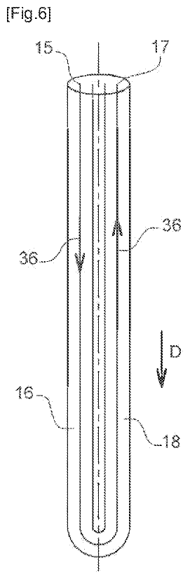

FIGS. 5 and 6 respectively illustrate two embodiments of the invention wherein the entrance end 15 and the exit end 17 of the diagnostic fibers 13 are both placed at the same end of the cable.

In FIG. 5, the entrance end 15 and the exit end 17 are one and the same end of the diagnostic fiber 13. The diagnostic fiber 13 comprises a distal end 19 opposite the entrance end 15. The distal end 19 is arranged to reflect the light inside the diagnostic fiber 13. For example, the distal end 19 has a straight split facilitating a Fresnel reflection of an incident beam 36 as a reflected beam 37. The light source 21 sends a light beam 31 into the diagnostic fiber 13 via the entrance end 15, the incident beam 36 corresponds to some of the light beam 31 that penetrated into the diagnostic fiber 13. Next, the incident beam 36 is reflected as a reflected beam 37. Part of the reflected beam 37 exits the diagnostic fiber 13 via the exit end 17 in the form of an exit beam 33.

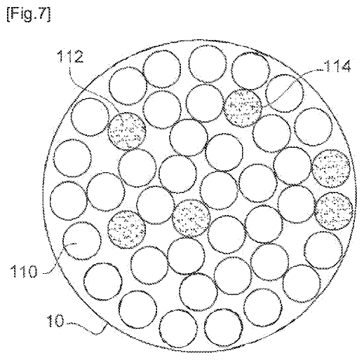

In FIG. 6, the diagnostic fiber 13 is folded in two so that the entrance end 15 and the exit end 17 are juxtaposed. More generally, all the strands of the set in FIG. 7 are folded in two parts and the set comprises a first portion 16 comprising all of the first parts of the strands and a second portion 18 comprising all of the second parts of the strands. The light source 21 sends a light beam 31 into the diagnostic fiber 13 via the entrance end 15, the incident beam 36 corresponds to some of the light beam 31 that penetrated into the fiber 13. Next, the incident beam 36 propagates up to the exit end 17. Part of the incident beam exits the fiber 13 via the exit end 17 in the form of an exit beam 33.

As a variant, the entrance end 15 and the exit end 17 are at two discrete ends of the set of strands. In this case, the first optical sensor 23, located at the exit end 17, is separated from the rest of the components of the diagnostic device 2, located at the entrance end 15. Data communication can be established between the first optical sensor 23 and certain other components of the diagnostic device 2.

In the example in FIG. 7, the first optical sensor 23 is a camera. FIG. 7 shows an image 10 of one end of a set of strands given by the camera. In this set of strands, the diagnostic fibers are the strands themselves. The image 10 comprises white dots 110 corresponding to intact strands, gray dots 112 corresponding to damaged strands and black dots 114 corresponding to broken strands. The image 10 makes it possible to know the precise mechanical state of a set of strands in a reliable and efficient manner.

The data provided by the diagnostic device 2 can make it possible to determine a lifespan for the set of strands, for example by virtue of an analysis of the image 10 based on predefined criteria. These criteria can be the rate of intact strands, the rate of damaged strands and the rate of broken strands.

The diagnostic device 2 comprises a power supply. To allow the diagnostic device 2 to be self-contained, the power supply can be a battery. The diagnostic device 2 can comprise a sealed enclosure making it possible to protect the electronic and optical components of the diagnostic device 2.

The assembly E can comprise a communication module programmed to send the signal from the optical sensor or sensors 23, 25 to a remote control unit. The data can be sent by means of acoustic waves or electrical cables. This makes it possible to perform a remote diagnosis on a set of strands. The diagnosis can be performed in real time.

It will be understood that various modifications and/or improvements obvious to the person skilled in the art may be made to the various embodiments of the invention disclosed or mentioned in the present description without departing from the scope of the invention. In particular, it is possible to combine the various embodiments together.

1. An assembly comprising a set of strands, the strands extending mainly in a so-called direction of tension in which the set of strands is intended to experience tensile stresses, all the strands that form the set are made from the same material with the same mechanical tensile strength,
characterized in that the strands are able to conduct light at least for certain wavelengths of light,
in that at least one strand of the set forms a diagnostic fiber so that the diagnostic fiber is able to conduct light, the light propagating through the diagnostic fiber between an entrance end and an exit end,
and in that the assembly comprises a diagnostic device comprising:
a light source arranged to send a light beam into the diagnostic fiber at the entrance end,
a first optical sensor capable of delivering a signal representative of the light intensity in the exit end of the diagnostic fiber, the light intensity in the exit end of the diagnostic fiber being correlated to the mechanical state of the diagnostic fiber.

2. The assembly according to claim 1, characterized in that the set of strands is a mooring and/or anchor cable.

3. The assembly according to claim 1, characterized in that the set of strands is a fabric band or even a strap.

4. The assembly according to claim 1, characterized in that the diagnostic fiber is made of polymer and preferably nylon.

5. The assembly according to claim 1, characterized in that the entrance end and the exit end are one and the same end of the diagnostic fiber and in that the diagnostic fiber comprises a distal end opposite the entrance end and reflecting the light inside the diagnostic fiber.

6. The assembly according to claim 1, characterized in that the diagnostic fiber is folded in two so that the entrance end and the exit end are juxtaposed.

7. The assembly according to claim 1, characterized in that the diagnostic device further comprises:
a second optical sensor, and
a beam splitter arranged to split a light beam from the light source into a first beam sent into the diagnostic fiber and a second beam sent into the second optical sensor.

8. The assembly according to claim 1, characterized:
in that the set of strands comprises several diagnostic fibers, and
in that the first optical sensor is a camera generating images of the exit ends of the diagnostic fibers.

9. The assembly according to claim 1, characterized in that it comprises a communication module programmed to send the signal from the optical sensor or sensors to a remote control unit.
